(19) United States
(12) Patent Application Publication
(10) Pub. No.: US 2012/0131607 A1
(43) Pub. Date: May 24, 2012

(54) SYSTEM AND METHOD FOR PROVIDING ADVERTISEMENTS IN IPTV SERVICE

(75) Inventor: Moon-Kyu KIM, Seoul (KR)

(73) Assignee: SAMSUNG ELECTRONICS CO., LTD., Suwon-si (KR)

(21) Appl. No.: 13/360,451

(22) Filed: Jan. 27, 2012

Related U.S. Application Data
(63) Continuation of application No. 12/258,089, filed on Oct. 24, 2008.

(30) Foreign Application Priority Data
Feb. 12, 2008 (KR) 10-2008-0012665

(51) Int. Cl. H04N 21/80

(52) U.S. Cl. 725/32

(57) ABSTRACT

A system and method for providing advertisements in Internet Protocol Television (IPTV) service are provided. The system includes a content server that stores content data; an advertisement server that stores advertisement data; a tag server that collects tag information input from a plurality of users, creates and updates a tag cloud for the content data; and a set-top box that receives the tag cloud, the advertisement data, and the content data and outputs the content data and the received tag cloud to a display unit., The set-top box transmits the tag cloud to the advertisement server while the content data is output and the advertisement server prepares a list of advertisements based on the tag cloud. The set-top box receives the advertisement data from the advertisement server according to the advertisement list and outputs the advertisement data to the display unit.

### CROSS-REFERENCE TO RELATED APPLICATION

This is a continuation of U.S. application Ser. No. 12/258,089 filed Oct. 24, 2008, which claims priority from Korean Patent Application No. 10-2008-0012665 filed on Feb. 12, 2008 in the Korean Intellectual Property Office, the disclosures of which are incorporated herein by reference in their entirety.

### BACKGROUND OF THE INVENTION

1. Field of the Invention

The present invention relates to a system and method for providing advertisements in Internet Protocol Television (IPTV) service, and more particularly, to a system and method for providing advertisements in IPTV service for providing customized advertisements in consideration of content data provided to a user and user's propensity or preference for the provided content data.

2. Description of the Related Art

Recently, IPTV service providing broadcasting contents and additional services using internet at high speed has emerged in the market and is rapidly growing.

IPTV service is similar to general cable broadcasting or satellite broadcasting in that it provides video contents including video, but is different in that it is provided between users and service providers. Accordingly, unlike the conventional broadcasting service in which content providers, including broadcasting stations, have taken the lead in providing broadcasting programs, the IPTV service has enabled users to take the lead in broadcasting.

IPTV service allows much information about users to be collected based on the interactivity using internet. However, according to the conventional IPTV service, the information about users cannot be sufficiently utilized. Rather, advertisements unilaterally produced by broadcasting providers are only being provided to users.

Accordingly, it is necessary to provide an IPTV advertisement system combined with a user customizable advertisement for the Web 2.0 age to allow users to actively and directly participate in production of advertisements.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a system for providing advertisements in IPTV service for providing customized advertisements in consideration of content data provided to a user and user's propensity for the provided content data by providing the advertisements according to a list of advertisements prepared based on tag information input by the user while the content data is provided to the user.

According to an aspect of the present invention, there is provided a system for providing advertisements in IPTV service, the system including a content server that stores content data to be provided to a user, an advertisement server that stores advertisement data to be provided to a user, a tag server that collects tag information input from a plurality of users on a network, creates a tag cloud for the content data for the users and updates the same, and a set-top box that receives the tag cloud for the content data, the advertisement data, and the content data and outputs the received tag cloud to a display unit, wherein the set-top box transmits the tag cloud for the content data to the advertisement server while the content data is output, the advertisement server prepares a list of advertisements based on the tag cloud for the content data, the advertisement data, and the content data and outputs the received tag cloud to a display unit, wherein the set-top box transmits the tag cloud for the content data to the advertisement server while the content data is output, the advertisement server prepares a list of advertisements based on the tag cloud for the content data, and the set-top box receives the advertisement data from the advertisement server according to the advertisement list and outputs the advertisement data to the display unit.

According to another aspect of the present invention, there is provided a method for providing advertisements in IPTV service, the method including receiving content data from a content server and outputting the same, receiving a tag cloud for the content data from a tag server while the content server is output, and outputting the same, transmitting the tag cloud to an advertisement server and preparing a list of advertisements based on the tag cloud, and receiving the advertisement data stored in the advertisement server according to the advertisement list and outputting the advertisement data to the display unit, wherein the tag server collects the tag information input by a plurality of users on a network, creates a tag cloud for the content data for the users and updates the same.

According to still another aspect of the present invention, there is provided a method for providing advertisements in IPTV service, the method including receiving content data from a content server and outputting the received content data, receiving a tag cloud for the content data from a tag server while the content server is output, and outputting the received tag cloud, receiving tag information from a user, transmitting the tag information and the tag cloud to an advertisement server and preparing a list of advertisements based on the tag information and the tag cloud, and receiving the advertisement data stored in the advertisement server according to the advertisement list and outputting the advertisement data to the display unit, wherein the tag server collects the tag information input from a plurality of users on a network, creates the tag cloud for the content data, and updates the tag cloud.

### BRIEF DESCRIPTION OF THE DRAWINGS

The above and other aspects of the present invention will become more apparent by describing in detail exemplary embodiments thereof with reference to the attached drawings in which:

FIG. 1 is a schematic diagram of a system for providing advertisements in IPTV service according to an exemplary embodiment of the present invention;

FIG. 2 is a diagram illustrating a tag cloud according to an exemplary embodiment of the present invention;

FIG. 3 is a diagram illustrating a tag cloud structure of content according to an exemplary embodiment of the present invention;

FIG. 4 is flowchart illustrating a method for providing advertisements in IPTV service according to an exemplary embodiment of the present invention; and

FIG. 5 is flowchart illustrating a method for providing advertisements in IPTV service according to another exemplary embodiment of the present invention.

### DETAILED DESCRIPTION OF EXEMPLARY EMBODIMENTS OF THE INVENTION

Hereinafter, exemplary embodiments of the present invention will be described with reference to the accompanying drawings. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims.

The present invention is described hereinafter with reference to a block diagram and flowchart illustrations of a system and method for providing advertisements in IPTV service according to exemplary embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to create means for implementing the functions specified in the flowchart block or blocks. These computer program instructions may also be stored in a computer usable or computer-readable memory that can direct a computer or other programmable data processing apparatus to function in a particular manner, such that the instructions implement the function specified in the flowchart block or blocks. The computer program instructions may also be loaded onto a computer or other programmable data processing apparatus to cause a series of operational steps to be performed on the computer or other programmable apparatus to produce a computer implemented process for implementing the functions specified in the flowchart block or blocks.

In addition, each block may represent a module, a segment, or a portion of code, which may comprise one or more executable instructions for implementing the specified logical functions. It should also be noted that in other implementations, the functions noted in the blocks may occur out of the order noted or in different configurations of hardware and software. For example, two blocks shown in succession may, in fact, be executed substantially concurrently, or the blocks may sometimes be executed in the reverse order, depending on the functionality involved.

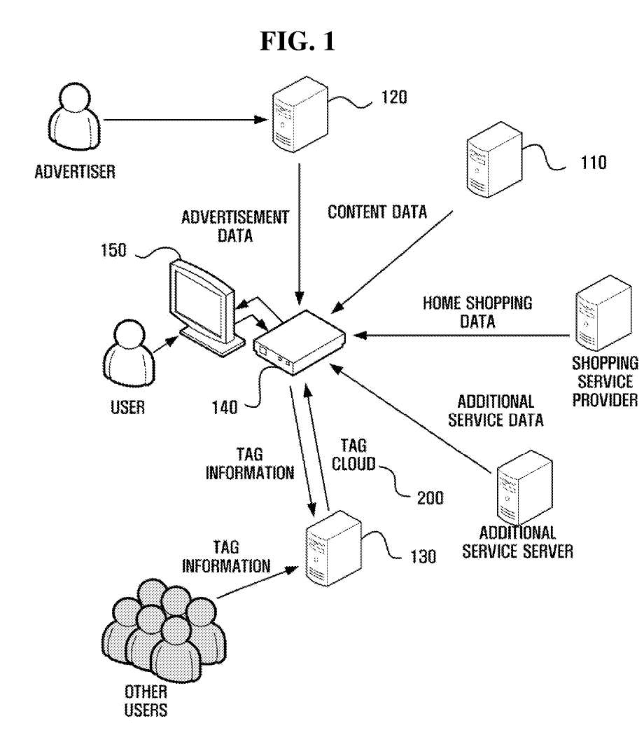

FIG. 1 is a schematic diagram of a system for providing advertisements in IPTV service according to an exemplary embodiment of the present invention.

The system for providing advertisements in IPTV service according to an exemplary embodiment of the present invention may include a content server 110, an advertisement server 120, a tag server 130, and a set-top box 140. The set-top box 140 is connected to a display unit 150, wherein the display unit 150 may be a cathode ray tube (CRT), a liquid crystal display (LCD), a plasma display panel (PDP), a digital light processing (DLP) projector, an organic light emitting diode (OLED) display.

The content server 110, the advertisement server 120, the tag server 130, and the set-top box 140 are connected to a network around the set-top box 140, and the content server 110, the advertisement server 120, and the tag server 130 are connected to one another via an interconnecting network so as to exchange information. Alternatively, the content server 110, the advertisement server 120, and the tag server 130 may be a physically identical server.

The content server 110 stores a variety of content data provided via the Internet, such as broadcasting content, home shopping programs, online games, MP3 files, and additional services. If the user inputs his/her desired content data, the set-top box 140 transmit the user's input to the content server 110 via a network, and the content server 110 transmits content data regarding details of the input to the set-top box 140 using a streaming server or a download server.

The advertisement server 120 stores a variety of advertisement data to allow the set-top box 140 to provide users with customized advertisement service. Advertisers can enter their advertisement data on the advertisement server 120. The advertisement data may include identifiers (IDs) of the advertisement data, and data having tags associated with the advertisement data. The advertisement server 120 prepares an optimized list of advertisements based on a tag cloud 200 transmitted from the set-top box 140. The advertisement list is prepared by comparing a variety of tag information including the tag cloud 200 transmitted from the set-top box 140 with the tags associated with the advertisement data, which will later be described in more detail.

The advertisement server 120 and the content server 110 may be a physically identical server, as described above, or may be independent servers.

As like the content data, advertisement data may be provided to the set-top box 140 through a streaming server or a download server.

The tag server 130 collects a variety of tag information input by a plurality of users on a network, and creates and updates a tag cloud 200 for the content data that is currently provided to a pertinent user.

The tag cloud 200 is a visual presentation displayed on a web site or a display screen by analyzing and visually arranging tags related with pertinent data in consideration of their importance and popularity. The tags are usually arranged in a two-dimensional table-like format. In this case, the tags may be arranged alphabetically (e.g., in alphabetical order). The respective tags may be represented in different types by varying colors and thicknesses of font according to their importance (or popularity) in order to emphasize the visual importance. Selecting one among the tags takes the user automatically to a web page linked to the selected tag. For example, while a content item, such as a movie, is output through a display device or TV 150, the tag cloud 200 allows the user to see how many tags are associated with the content item, e.g., movie, currently being output, and which type of content is being output.

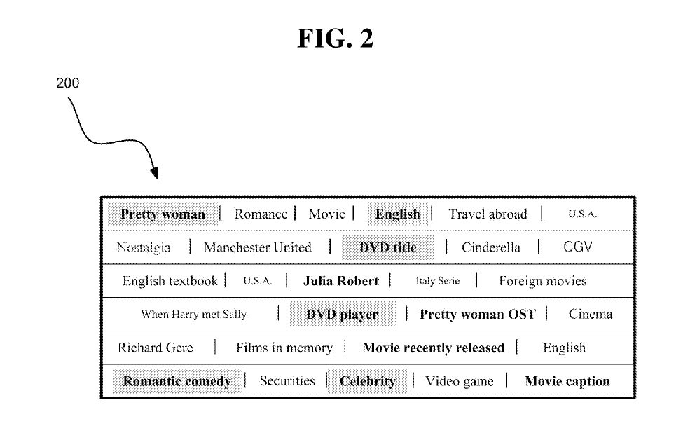

FIG. 2 is a diagram illustrating an example of a tag cloud 200 according to an exemplary embodiment of the present invention, illustrating a visual representation of tags displayed while a movie ‘Pretty Woman’ is on through the TV 150.

While a movie ‘Pretty Woman’ is output through the display unit 150, the tag cloud 200 is created based on the tag information input by the plurality of users viewing the same content item, i.e., the movie ‘Pretty Woman.’ As shown in FIG. 2, the tag cloud 200 has a plurality of tags arranged, including ‘Pretty Woman’, ‘Romance’, ‘Movie’, ‘Romantic Comedy’, ‘DVD title’ and so on. The tag information is represented in different manners according to the popularity or importance by varying font sizes, colors or thicknesses. The popularity can be given according to the number of times that a tag is repeatedly entered. Here, the popularity can also be calculated by applying different weights to the tag information input in various manners, which will be described below in more detail together with a description of the tag information.

The tag information includes a variety of information that a user enters using an input device (e.g., a mouse, a remote controller, a keyboard, etc.) connected to the set-top box 140 while a content item is output. For example, among tags arranged in the tag cloud 200, the user may select one tag using a mouse or a remote controller and the tag information may be the selected tag that creates the tag cloud 200. In addition, if the user requests for information search by entering a particular keyword into a search field while viewing the content item, an information server storing a variety of information provides the user with data corresponding to the information. The tag information may be a keyword entered by the user, the tag information creating the tag cloud 200. Further, if a product is sold through a purchase system associated with pertinent advertisement data output to the display unit 150, the tag information that is used to create the tag cloud 200 may be a tag linked with the pertinent advertisement data. In this way, the tag information, which the user enters in various manners while viewing a content item, is transmitted to the tag server 130 to create the tag cloud 200.

The tag cloud 200 is continuously updated by a plurality of users. A number of updates may gradually increase the accuracy of a tag for content data of interest.

The popularity of each of tags that creates the tag cloud 200 can be calculated by applying different weights to the tag information provided in various manners. As described above, the tags creating the tag cloud 200 can be represented in different manners according to the popularity. Here, in order to create the tag cloud 200, different weights are applied to the tag information in calculating the popularity. For example, if a product is sold through a purchase system associated with advertisement data, suggesting a direct advertisement effect, a high weight may be given to a tag corresponding to the advertisement data. As described above, the tag cloud 200 for the corresponding content data can be created based on the tag information entered by the user to then be continuously updated. If the plurality of users concurrently view the same content item on a real-time basis, the tag cloud 200 can be created based on the tag information that the plurality of users enter on a real-time basis. In addition, in a case of an display unit 150, the user can selectively download a content item to view the same. Accordingly, whenever the user selects and views a pertinent item, the tag information entered by the user is cumulatively updated over time to then create the tag cloud 200.

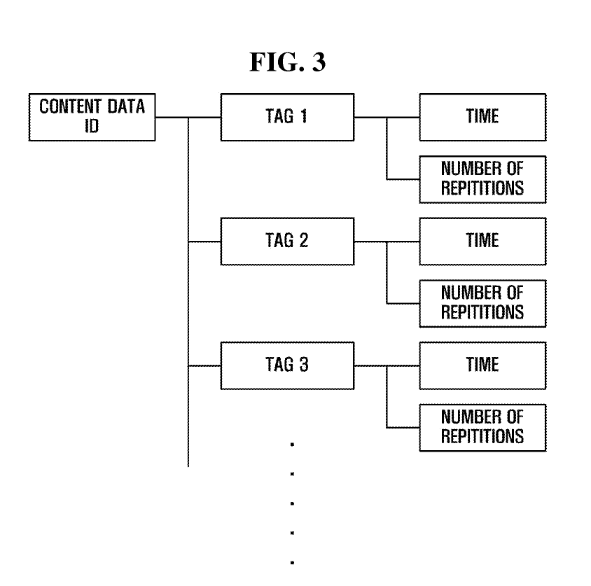

FIG. 3 is a diagram illustrating a tag cloud structure of content according to an exemplary embodiment of the present invention.

As shown in FIG. 3, the tag cloud 200 may be created whenever the content data is provided from the content server 110, and includes content data IDs for identifying content data. In addition, the tag cloud 200 may also include tags. Each tag may include a time at which the user enters the tag, and a number of times that the tag has been selected repeatedly as a favorite to determine its popularity.

Since it is possible to determine the popularity of each of the plurality of tags that create the tag cloud 200 over time while the content data is displayed to the user, a list of advertisements can be prepared in consideration of the tag cloud 200.

As described above, the number of times that the tag is repeatedly entered in various manners may include a number of times that different weights are applied to the tag information provided in various manners. For example, if a product is sold through a purchase system associated with advertisement data, suggesting a direct advertisement effect, a high weight may be given to a tag corresponding to the advertisement data, so that one product purchase is considered that a tag associated with the product is entered twice.

The set-top box 140 receives content data from the content server 110 and outputs the received content data to the display unit 150. In addition, the set-top box 140 receives advertisement data from the advertisement server 120 according to the advertisement list and outputs the received advertisement data to the display unit 150. Further, the set-top box 140 receives the tag cloud 200 from the tag server 130 and outputs the received tag cloud to the display unit 150. The set-top box 140 includes a decoder (not shown) for decoding audio data and video data. The decoder decodes encoded data transmitted via an Internet network (e.g., media data including content data, advertisement data, and so on) and outputs the decoded data to the display unit 150.

The tag cloud 200 may be continuously output to the display unit 150 in an overlay format, for example, together with the content data selected by the user, as soon as the content data is output to the display unit 150 for the first time. The tag cloud 200 is received from the tag server 130, updated at constant time intervals by the tag server 130 and then output to the display unit 150. Alternatively, whenever a request for content data is received from the user, the tag cloud 200 may be received from the tag server 130 to then be output to the display unit 150.

The set-top box 140 transmits the tag cloud 200 to the advertisement server 120 when a predetermined time is elapsed while the content data is output, whenever a predetermined time is elapsed, or when the user enters the tag information. Here, the advertisement server 120 prepares a list of advertisements based on the tag cloud 200. When the tag information enters the tag information, the tag cloud 200 and the tag information input by the user are simultaneously transmitted to the advertisement server 120, and the advertisement server 120 prepares the advertisement list based on the received tag cloud 200 and the tag information. A feature of the present invention lies in that advertisements tailored to user's propensity are provided to a user on the basis of the assumption that the tag information input by the user while viewing the content data is closely related to the user's preference.

The set-top box 140 accesses the advertisement server 120 to receive advertisement data according to the advertisement list from the advertisement server 120 and provides the user with the received advertisement data.

The advertisement server 120 prepares the advertisement list based on the tag cloud 200 received from the set-top box 140. The advertisement list can be prepared in various manners.

For example, if the advertisement server 120 receives the tag cloud 200 and tag information from the set-top box 140, the tag information including various tags arranged in the tag cloud 200 and selected by the user using a mouse or a remote controller, a list of advertisements can be prepared by allocating each 25% to the tag information selected from the tag cloud 200, advertisement associated with a tag having high correlation with the selected tag information, advertisement associated with a current popular tag, and proposed advertisement proposal of a newcomer, respectively. For example, if a user who is viewing the movie ‘Pretty woman’ selects a tag ‘English’ from the tag cloud 200, weights of each 25% are allocated to an advertisement such as an English textbook or an English language center associated with English, an advertisement associated with studying in U.S.A., which is a tag that is closely related with English, an advertisement associated with celebrity boutique, which is a tag that is closely related with ‘celebrity’ that is currently most popular, and an advertisement associated with new products of a newcomer ‘A,’ respectively. The foregoing description is provided for illustration of example only. Rather, the method of preparing the advertisement list is not to be limited by the foregoing exemplary example and can be prepared in various manners. The advertisements tailored to user preference or interest can be provided to users based on the prepared advertisement list at an appropriate time, for example, before, during, or after viewing content data.

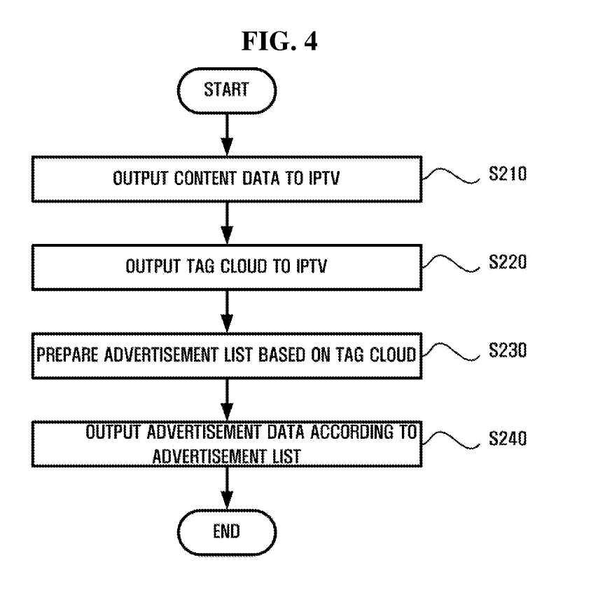

FIG. 4 is flowchart illustrating a method for providing advertisements in IPTV service according to an exemplary embodiment of the present invention.

First, the set-top box 140 accesses the content server 110 through a network to receive content data selected by the user from the content server 110 and outputs the selected content data to the display unit 150 in operation S210.

While the content data is output, the set-top box 140 receives the tag cloud 200 regarding the content data output from the tag server 130 and outputs the same to the display unit 150 in operation S220. The tag cloud 200 may be output to the display unit 150 with the content data at the same time. Alternatively, whenever a request for the content data is received from the user, the tag cloud 200 may be output to the display unit 150. Here, the tag cloud 200 may be output in various manners, including in an overlay format with content data, or a screen division manner.

The set-top box 140 periodically transmits the tag cloud 200 to the advertisement server 120 when a predetermined time is elapsed after the content data is output, or whenever a predetermined time is elapsed. Then, the advertisement server 120 prepares a list of advertisements based on the tag cloud 200 in operation S230. The tag server 130 collects tag information input from a plurality of users on a network, creates the tag cloud 200 for the content data output on a real-time basis, and updates the tag cloud 200 based on the tag information.

Here, the tag information input by the user may include a tag of interest, which is selected by the user from the tag cloud 200 output to the display unit 150 by means of an input device, a search keyword that the user enters while the content data is output, and a tag linked with pertinent advertisement data when a product is sold through a purchase system associated with the pertinent advertisement data output to the display unit 150.

The set-top box 140 receives the advertisement data stored in the advertisement server 120 according to the prepared advertisement list and provides users with tailored advertisements in operation S240.

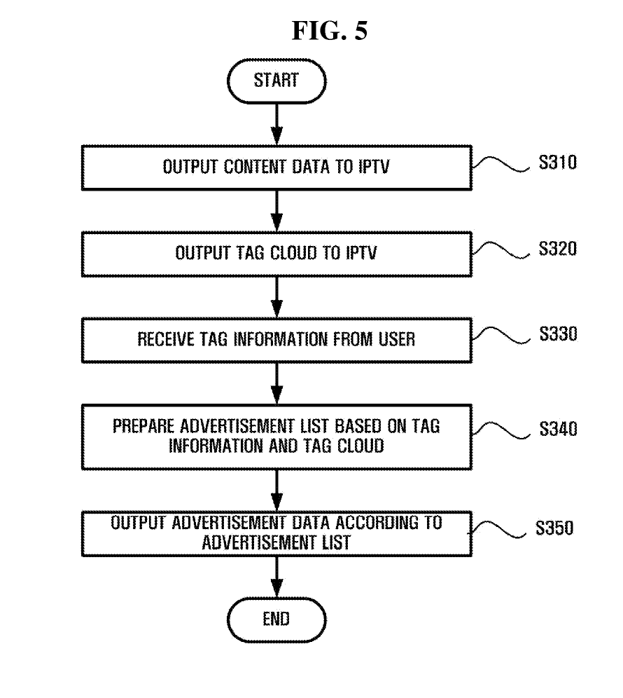

FIG. 5 is flowchart illustrating a method for providing advertisements in IPTV service according to another exemplary embodiment of the present invention.

First, the set-top box 140 accesses the content server 110 through a network to receive content data selected by the user from the content server 110 and outputs the selected content data to the display unit 150 in operation S310.

While the content data is output, the set-top box 140 receives the tag cloud 200 regarding the content data output from the tag server 130 and outputs the tag cloud to the display unit 150 in operation S320.

The tag information is input by the user in operation S330. Here, the tag information input by the user may include a tag of interest, which is selected by the user from the tag cloud 200 output to the display unit 150 by means of an input device, a search keyword that the user enters while the content data is output, and a tag linked with corresponding to advertisement data when a product is sold through a purchase system associated with advertisement data output to the display unit 150.

After the tag information is input by the user, the input tag information and the current tag cloud 200 are transmitted to the advertisement server 120. Then, the advertisement server 120 prepares a list of advertisements based on the tag information and the current tag cloud 200 in operation S340.

Finally, the set-top box 140 receives the advertisement data stored in the advertisement server 120 according to the prepared advertisement list and provides users with tailored advertisements in operation S350.

As described above, in the system and method for providing advertisements in IPTV service according to the present invention, advertisements tailored to user's can be provided by providing users with the advertisements according to a list of advertisements prepared based on content data and user's propensity or preference for the content data.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present exemplary embodiments be considered in all respects as illustrative and not restrictive, reference being made to the appended claims rather than the foregoing description to indicate the scope of the invention.

What is claimed is:

1. A tag server that collects tag information input from a plurality of users on a network, creates a tag cloud for the content data for the users to view based on the collected tag information, and provides the created tag cloud, receiving the content data, to a set-top box output through a television (TV).

2. The tag server of claim 1, wherein the tag cloud includes a plurality of tags associated with the content data and popularity for each of the plurality of tags.

3. The tag server of claim 2, wherein tags that make up the tag cloud represents in different manners according to the popularity.

4. The tag server of claim 1, wherein the tag cloud further includes a time at which entered the tag information.

5. The tag server of claim 1, wherein the set-top box transmits the tag cloud to the advertisement server storing advertisement data to be provided to the users, and receives the advertisement data from the advertisement server according to the advertisement list drawn up based on the tag cloud and outputs it through the TV.

6. The tag server of claim 5, wherein the tag information includes at least one among a tag selected by the user from the tag cloud output through the TV, a search keyword that the user enters, and a tag linked with the advertisement data, if a product is sold through a purchase system associated with the advertisement data.

7. The tag server of claim 6, wherein respective information included in the tag information is assigned a different weighting.

8. A method for providing a tag cloud of tag server, the method comprising:
collecting tag information input from a plurality of users on a network;
creating the tag cloud for the content data for the users to view based on the collected tag information; and
providing the created tag cloud, receiving the content data, to a set-top box output through a television (TV).

9. The method of claim 8, wherein the tag cloud includes a plurality of tags associated with the content data and popularity for each of the plurality of tags.

10. The method of claim 9, wherein tags that make up the tag cloud represents in different manners according to the popularity.

11. The method of claim 8, wherein the tag cloud further includes a time at which entered the tag information.

12. The method of claim 8, the method further comprising:
transmitting, by the set-top box, the tag cloud to the advertisement server storing advertisement data to be provided to the users; and
drawing up, by the advertisement server, advertisement list based on the tag cloud and transmitting advertisement data according to the advertisement list to the set-top box.

13. The method of claim 12, wherein the tag information includes at least one among a tag selected by the user from the tag cloud output through the TV, a search keyword that the user enters, and a tag linked with the advertisement data, if a product is sold through a purchase system associated with the advertisement data.

14. The method of claim 13, wherein respective information included in the tag information is assigned a different weighting.

15. A display device that outputs content data received through a set-top box and a tag cloud for the content data, and outputs advertisement data according to the tag cloud received through the set-top box from an advertisement server storing the advertisement data to be provided to users.

16. The display device of claim 15, wherein the tag cloud includes a plurality of tags associated with the content data and popularity for each of the plurality of tags.

17. The display device of claim 16, wherein tags that make up the tag cloud represents in different manners according to the popularity.

18. The display device of claim 15, wherein the tag cloud is created and updated by collecting tag information, by the tag server input from a plurality of users on a network, and
wherein the tag information includes at least one among a tag selected by the user from the output tag cloud, a search keyword that the user enters, and a tag linked with the advertisement data, if a product is sold through a purchase system associated with the advertisement data.

19. The display device of claim 18, wherein respective information included in the tag information is assigned a different weighting.

20. The display device of claim 15, wherein the tag cloud further includes a time at which entered the tag information.

21. The display device of claim 15, wherein the set-top box transmits the tag cloud to the advertisement server, and the advertisement server transmits the advertisement data according to the advertisement list drawn up based on the tag cloud to the set-top box.

22. A method for providing advertisement of a display device, the method comprising:
outputting content data received through a set-top box and a tag cloud for the content data; and
outputting advertisement data according to the tag cloud received through the set-top box from an advertisement server storing the advertisement data to be provided to the users.

23. The method device of claim 22, wherein the tag cloud includes a plurality of tags associated with the content data and popularity for each of the plurality of tags.

24. The method device of claim 23, wherein tags that make up the tag cloud represents in different manners according to the popularity.

25. The method device of claim 22, wherein the tag cloud is created and updated by collecting tag information, by tag server input from a plurality of users on a network, and
wherein the tag information includes at least one among a tag selected by the user from the output tag cloud, a search keyword that the user enters, and a tag linked with the advertisement data, if a product is sold through a purchase system associated with the advertisement data.

26. The method device of claim 25, wherein respective information included in the tag information is assigned a different weighting.

27. The method device of claim 22, wherein the tag cloud further includes a time at which entered the tag information.

28. The method device of claim 22, the method further comprising:
transmitting, by the set-top box, the tag cloud to the advertisement server; and
drawing up an advertisement list based on the tag cloud and transmitting the advertisement data according to the advertisement list to the set-top box, by the advertisement server.
